(19) United States
(12) Patent Application Publication
(10) Pub. No.: US 2016/0136908 A1
(43) Pub. Date: May 19, 2016

(54) APPARATUS AND METHOD FOR BUTT JOINING STRIP-SHAPED MEMBERS

(71) Applicant: VMI HOLLAND B.V., Epe (NL)

(72) Inventor: Luuk VAN TIENEN, EPE (NL)

(21) Appl. No.: 14/898,758

(22) PCT Filed: Jun. 5, 2014
(86) PCT No.: PCT/NL2014/050356

§ 371 Date: Dec. 16, 2015

(30) Foreign Application Priority Data
Jun. 17, 2013 (NL) 2010985

(51) Int. Cl. B29D 30/30; B65H 21/00; B29D 30/24

(52) U.S. Cl. CPC B29D 30/3007; B29D 30/242; B65H 21/00; B29D 2030/207

(57) ABSTRACT

An apparatus and method for joining a leading and a trailing end of one or more strip-shaped members, the apparatus includes: a working surface including a butt line, an arranging device for arranging the leading and trailing end of the member(s) at the butt line, a stitching device for pushing the leading and trailing ends against each other to obtain a butt splice, a transfer device for moving a separator strip onto and away from the working surface, wherein the separator strip is a flat strip including a splice band of a flexible material and a first release surface at a side which faces away from the working surface, and wherein the apparatus is arranged for pulling the separator strip from underneath the butt spliced strip-shaped member(s).

### BACKGROUND

The invention relates to an apparatus and a method for arranging a leading and a trailing end of one or more strip-shaped members on a surface to butt against each other and to butt join (also known as ‘butt splice’) these ends.

In order to butt join the ends, it is necessary to push both ends against each other. In particular, when the surface is an adhesive surface and/or is an adhesive surface of another strip-shaped member, problems may arise when pushing both ends against each other.

In the U.S. Pat. No. 5,348,600, for example, a method and an apparatus is disclosed which make it possible to first wind a first belt-shaped member around a forming drum and to butt join the leading and trailing ends of said first belt-shaped member, and to subsequently wind a second belt-shaped member around said forming drum with the first belt-shaped member and to butt join the leading and trailing ends of said second belt-shaped member. These belt-shaped members comprise surfaces of uncured rubber and these surfaces adhere to each other when such belt-shaped members are arranged on top of each other. The method as disclosed in this United States Patent comprises the steps of:

attaching an auxiliary bar having a shape of a substantially triangular prism to the forming drum in such a manner that the auxiliary bar becomes parallel with an axis of the forming drum;

supplying a belt-shaped member cut to a predetermined length toward the forming drum in such a manner as to cause a leading end of the belt-shaped member to be attached to one of the side surfaces of the auxiliary bar;

supplying the belt-shaped member onto the forming drum while the forming drum is being rotated so as to wind the belt-shaped member around the forming drum, and attaching a trailing end of the belt-shaped member to another side surface of the auxiliary bar;

removing the auxiliary bar off the forming drum; and

causing the leading end and the trailing end of the belt-shaped member to butt against each other on the forming drum.

Since the leading end and the trailing end of these belt-shaped member are attached to side surfaces of the auxiliary bar having the shape of a substantially triangular prism, the gripping of the ends of the belt-shaped member can be facilitated. However, in order to grip the leading and trailing end, gripping pawls are provided to grip each of the leading and trailing end at multiple positions which are arranged at a distance with respect to each other along said leading or trailing end. When using these gripping pawls to move the leading and trailing end to butt against each other, the leading and trailing end of the belt-shaped member undulate along the butt line. A disadvantage of the method and apparatus according to the U.S. Pat. No. 5,348,600 is, that at some positions along the butt line the leading and trailing end overlap, at other positions along said butt line the leading and trailing end are arranged at a distance from each other. Although the leading and trailing ends of the belt-shaped member can be joined by a joining roller to form a cylindrical member, the resulting joint is not of a constant quality along the butt line and shows an undulate pattern.

It is an object of the present invention to provide an apparatus and a method for butt joining strip-shaped members on a surface, which apparatus and method provides a more uniform joint along the butt line, even if the strip-shaped member adheres to the surface onto which the strip-shaped member is arranged.

### SUMMARY OF THE INVENTION

According to a first aspect, the invention provides an apparatus for arranging a leading and a trailing end of one or more strip-shaped members on a surface at or near a butt line, wherein the apparatus comprises:

a working surface comprising the butt line,

an arranging device for arranging the leading and/or the trailing end of one or more strip-shaped members at or near the butt line on the working surface,

a stitching device which is movable along the butt line, wherein said stitching device comprises a stitching member for pushing the leading and trailing ends against each other to obtain a butt splice,

a separator strip which is movable onto said working surface and away from said working surface, wherein said separator strip has a width, when arranged on said working surface, to cover said butt line and an area of said working surface on both sides adjacent to said butt line,

a transfer device for moving said separator strip onto said working surface and away from said working surface, characterized in that

said separator strip is a flat strip comprising a splice band of a flexible material and a first release surface at a side which faces away from said working surface, and

wherein said apparatus is arranged for pulling said separator strip in a pulling direction substantially parallel to the working surface from underneath the butt spliced leading and trailing end of the one or more strip-shaped members.

The apparatus of the invention thus contains a system to keep the leading and trailing end of the one or more strip-shaped members separated from the working surface, until the ends are spliced. At the position of the splice, a separator strip is placed on the working surface. The working surface can be a surface of a table top, a conveyor or a building drum, and in the context of this application can be a surface of a previously arranged strip-shaped member on said table top, conveyor or building drum. On the one hand a flexible splice band allows the splice band to follow the curvature of the working surface, which is particularly advantageous when the working surface is a circumferential surface of a drum. On the other hand, a flexible splice band allows to arrange the splice band in a loop as described below.

The separator strip comprises a first release surface at a side which faces away from said working surface in order to substantially prevent the leading and trailing end of the one or more strip-shaped member to adhere to the separator strip, in particular wherein said one or more strip-shaped members comprising an uncured rubber surface. Although the strip-shaped member may stick slightly to the release surface, the first release surface facilitates a smooth and easy release of the strip-shaped member and makes it possible that the leading and the trailing end can move or slide over said separator strip to enable said stitching member to push the leading and trailing ends against each other to obtain a butt splice. Thus the stitching of the leading and trailing end is performed with said separator strip still arranged on said surface, in particular between said surface and the leading and trailing end of the one or more strip-shaped members. Since the leading and trailing ends are pushed against each other by said stitching member when it moves along the butt line, a more uniform butt splice is obtained, even if the strip-shaped member adheres firmly to the working surface, for example when the working surface is a surface of a previously arranged strip-shaped member, in particular when said strip-shaped member(s) comprising an uncured rubber surface.

In an embodiment, said transfer device is arranged to place said splice band on said working surface and to retain said splice band along said butt line at opposite sides of said working surface.

In an embodiment, said transfer device is arranged to place a loop of said splice band on said working surface, and to retain to and fro extending branches of said loop on a first side of the working surface and to retain a reversing loop part on a second side of the working surface, wherein said first and second side are arranged along said butt line at opposite sides of said working surface. In an embodiment, said transfer device is arranged to place said to and fro extending branches on top of each other on said working surface. Using a loop of said splice band is particularly advantageous when one of the working surface and strip-shaped member is of a sticky material, which may even stick slightly to the release surface, and the other one is essentially of a non-stick material. In this case the splice band can easily be removed by pulling at the branch of the loop that is arranged adjacent to the non-stick material, whereby the branch of the loop that is arranged adjacent to the sticky material will be peeled-off from said sticky material.

In an embodiment, a first branch of said to and fro extending branches of said loop is fixed to said transfer device, and wherein a second branch of said to and fro extending branches of said loop is connected to a roll for winding and un-winding said splice band. Preferably the first branch is arranged adjacent to the sticky material. When placing a loop of said splice band on said working surface, the splice band is un-wind. The winding of the splicing band onto the roll is used for pulling the splice band from underneath the butt spliced leading and trailing end of the one or more strip-shaped members. In an embodiment, the second branch is arranged between said first branch and said working surface.

In an embodiment, said transfer device is arranged to place two loops of said splicing band on said working surface and to retain to and fro extending branches of each of said two loops on a first side of the working surface and to retain a reversing loop part of each of said two loops on a second side of the working surface, wherein said first and second side are arranged along said butt line at opposite sides of said working surface. In an embodiment, said transfer device is arranged to place said to and fro extending branches of said two loops on top of each other on said working surface. Using a loop of said splice band is particularly advantageous when both the working surface and strip-shaped member are of a sticky material, which may even stick slightly to the release surface.

In an embodiment, for each one of said two loops a first branch of said to and fro extending branches is fixed to said transfer device, and wherein a second branch of said to and fro extending branches is connected to a roll for winding and un-winding said splicing band. In an embodiment, the second branches of said two loops are arranged between said first branches of said two loops. In this case the splice band can easily be removed by pulling at the central two branches of the two loops, whereby the branches of the loops that are arranged adjacent to the working surface and strip-shaped member will be peeled-off from said sticky material.

In an embodiment, the separator strip comprises a second release surface at a side which faces towards said working surface in order to substantially prevent the separator strip to adhere to said working surface. The first release surface, the second release surface and said transfer device make it possible to pull said separator strip from in-between the working surface and the stitched strip-shaped member(s).

In an embodiment, said pulling direction is substantially parallel to the butt line. Thus the separator strip is pulled from underneath and substantially along the butt splice, at least substantially without disturbing the part of the strip-shaped member adjacent the butt splice.

In an embodiment, said apparatus comprises a drum having a circumferential surface, and wherein said working surface comprises said circumferential surface of said drum or comprises a circumferential surface of another strip-shaped member arranged around said drum. When using a drum, the leading and the trailing end of one strip-shaped member can be arranged at or near the butt line on the working surface. Butt splicing said leading and trailing end of the one strip-shaped member, thus provides a substantially cylindrical member.

In an embodiment, said drum is rotatable around a center line thereof, and wherein said separator strip and/or said transfer device arranged to rotate together with said drum. In an embodiment, said separator strip and/or said transfer device is arranged to provide a rotation fixed coupling with said drum. When arranging a strip-shaped member onto the circumference of the drum, said drum is rotated. The leading end of the strip-shaped member, which is initially arranged onto the separator strip, can remain on said separator strip when at least the separator strip is arranged to rotate together with said drum when the drum is rotated for winding the strip-shaped member around said drum.

In an embodiment, said transfer device is arranged to place said splice band on said working surface and to retain said splice band along said butt line at opposite sides of said working surface.

In an embodiment, the splice band is made from a substantially non-adhesion material, in particular a material which substantially does not adhere to uncured rubber. An example of such a material is silicone rubber.

When using a separator of a flexible material, as described above, the separator needs to be held on both sides of the working surface in order to position the separator, in particular the splice band, on said working surface.

According to a second aspect, the invention provides a method for arranging a leading and a trailing end of one or more strip-shaped members on a surface at or near a butt line, wherein the method comprises the steps of:

providing a working surface comprising the butt line,

arranging a separator strip onto said working surface, wherein said separator strip is a flat strip comprising a splice band of a flexible material and a first release surface at a side which faces away from said working surface, and wherein said separator strip is arranged to cover said butt line and an area of said working surface on both sides adjacent to said butt line,

arranging the leading and the trailing end of one or more strip-shaped members at or near the butt line on the separator strip on said working surface,

pushing the leading and trailing ends against each other to obtain a butt splice, and

pulling said separator strip in a pulling direction substantially parallel to the working surface from underneath the butt spliced leading and trailing end of the one or more strip-shaped members.

In an embodiment, the splice band is placed on said working surface and retained along said butt line at opposite sides of said working surface.

In an embodiment, a loop of said splice band is placed on said working surface, and wherein to and fro extending branches of said loop are retained on a first side of the working surface and a reversing loop part is retained on a second side of the working surface, wherein said first and second side are arranged along said butt line at opposite sides of said working surface.

In an embodiment, said to and fro extending branches are placed on top of each other on said working surface.

In an embodiment, a first branch of said to and fro extending branches of said loop is fixed to said transfer device, and wherein a second branch of said to and fro extending branches of said loop is connected to a roll, wherein the method comprises winding and un-winding said splicing band.

In an embodiment, the second branch is arranged between said first branch and said working surface.

In an embodiment, two loops of said splicing band are placed on said working surface, and wherein to and fro extending branches of each of said two loops are retained on a first side of the working surface and a reversing loop part of each of said two loops is retained on a second side of the working surface, wherein said first and second side are arranged along said butt line at opposite sides of said working surface.

In an embodiment, said to and fro extending branches of said two loops are placed on top of each other on said working surface.

In an embodiment, for each one of said two loops a first branch of said to and fro extending branches is fixed to said transfer device, and wherein a second branch of said to and fro extending branches is connected to a roll, wherein the method comprises winding and un-winding said splicing band.

In an embodiment, the second branches of said two loops are arranged between said first branches of said two loops.

In an embodiment, the splice band is made from a substantially non-stick material, in particular a material which substantially does not stick to uncured rubber

In an embodiment, said separator strip comprises a second release surface at a side which faces towards said working surface.

In an embodiment, said pulling direction is substantially parallel to the butt line.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached drawings, in which:

FIGS. 1 to 7 schematically show the working of a first embodiment of an apparatus according to the invention,

FIGS. 8 to 11 schematically show the working of a second embodiment of an apparatus according to the invention, and

FIGS. 12A to 18B schematically show the working of a third embodiment of an apparatus according to the invention using a building drum.

### DETAILED DESCRIPTION OF THE INVENTION

The present invention provides a method and apparatus for arranging a leading and a trailing end of one or more strip-shaped members on a surface at or near a butt line, and for butt splicing said leading and trailing end to each other. The method and apparatus is preferably used for manufacturing green tires. In this application, the strip-shaped member is for example a body ply and the working surface is for example a pre-assembly.

A first exemplary embodiment is schematically shown in FIGS. 1 to 7. The working surface 3 can be a surface of a support device 14, for example a table top, a conveyor or a building drum, and in the context of this application can be a surface of a previously arranged strip-shaped member on said support device 14. Adjacent to a working surface 3 a separator strip system 11 is arranged. The separator strip system 11 comprises two rolls 9, 9′ of separator strips 5, 5′, also denoted as “splice band”. The splice bands 5, 5′ are of a flexible material. The separator strips 5, 5′ are wound on said rolls 9, 9′. The ends of the separator strips 5, 5′ are fixed to the holding frame 11 via holding bars 10, 10′, which are arranged at a distance to each other.

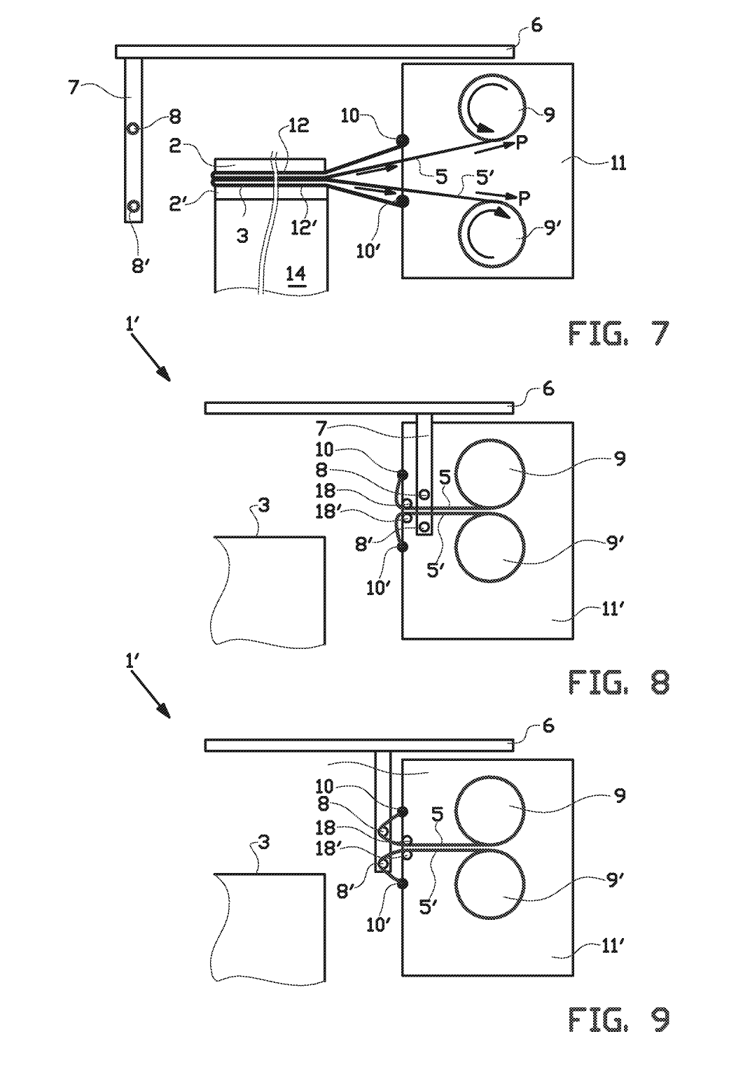

A transfer device 6 is arranged adjacent and over the working surface 3. The transfer device 6 comprises a transfer arm 7 which is movable from one side of the working surface 3 as shown in FIG. 1 to the other side of the working surface 3 as shown in FIG. 4. The transfer arm 7 is provided with two guide rolls 8, 8′. Preferably the two rolls 8, 8′ are freely rotatable arranged on the transfer arm 7 and are movable along the transfer arm 7.

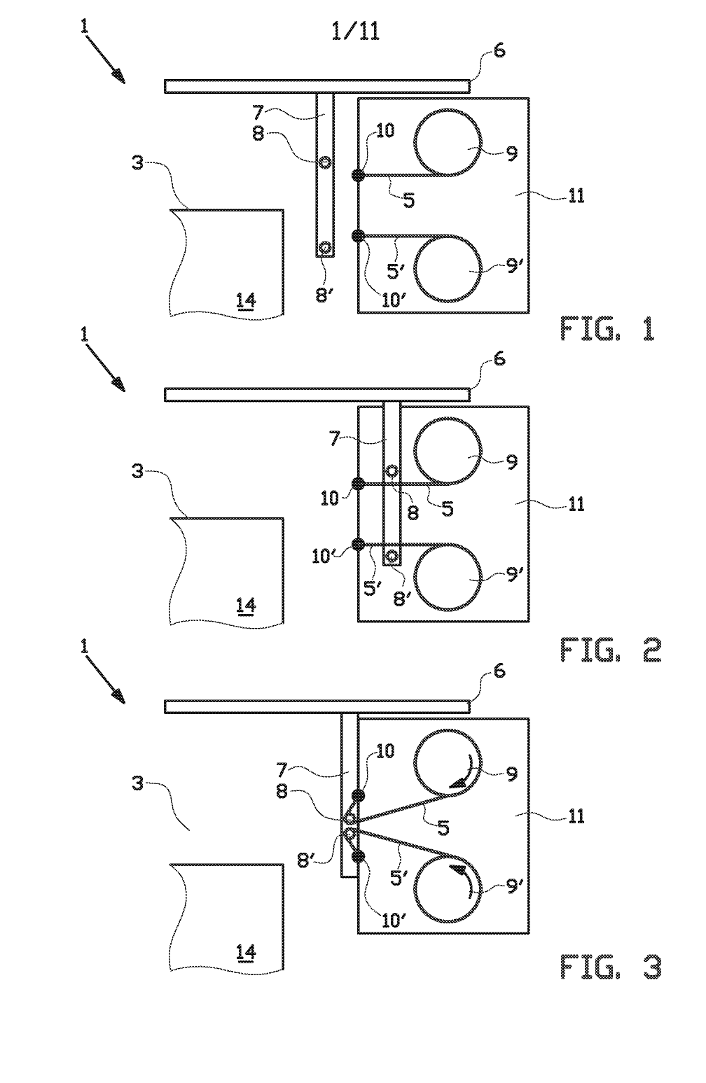

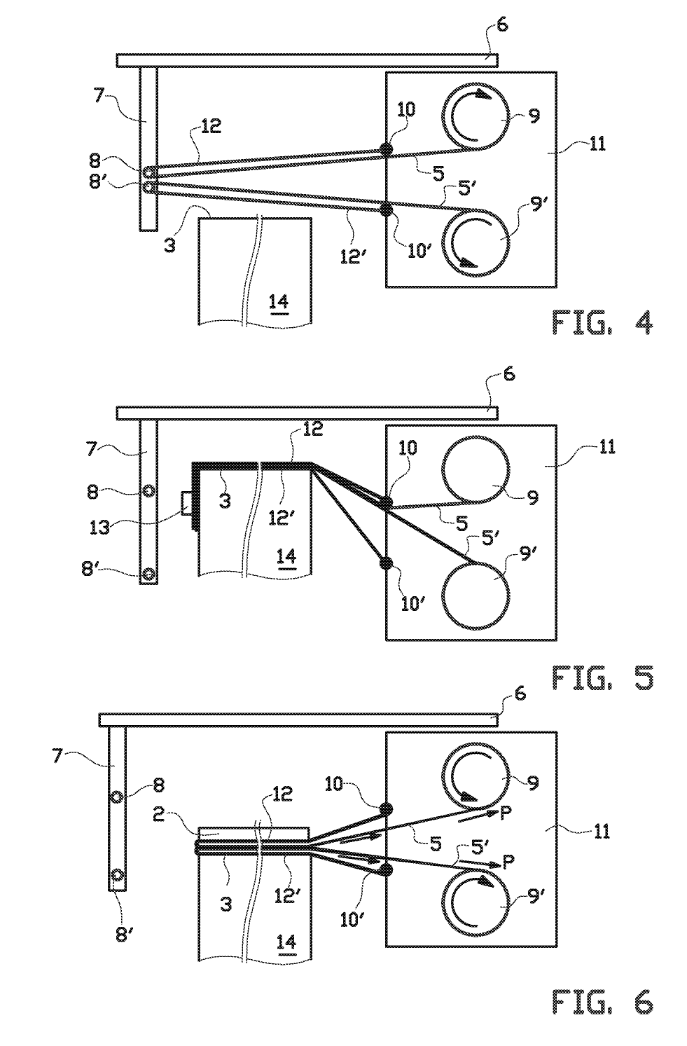

In the example, the two guide rolls 8, 8′ each pick up a separator strip 5, 5′. As shown in FIG. 2, the transfer arm 7 is arranged between the holding bars 10, 10′ and the rolls 9, 9′ with the separator strips 5, 5′ thereon. The guide rolls 8, 8′ are arranged so that the separator strips 5, 5′ are positioned in between the rolls 8, 8′. Subsequently, the rolls 8, 8′ are moved toward each other to a position wherein the distance between the rolls 8, 8′ is smaller than the distance between the holding bars 10, 10′. Then the transfer arm 7 is moved toward the working surface 3 and the guide rolls 8, 8′ are lead through the gap between the holding bars 10, 10′, as shown in FIG. 3.

As shown in FIG. 4, the transfer arm 7 is moved over the working surface 3 to the side facing away from the holding frame 11 and the separator strips are pulled over the working surface 3. Thus the transfer device 6 is arranged to arrange a first loop 12 and a second loop 12′ of said splice band 5, 5′ over said working surface 3, as shown in FIG. 4.

The first separator strip 5 comprises a first upper branch of said to and fro extending branches of said loop 12 which is fixed to said holding bar 10, and a second lower branch of said to and fro extending branches of said loop 12 which is connected to the roll 9 for winding and un-winding said splicing band 5. Thus the second branch is arranged between said first branch and said working surface 3. The second separator strip 5′ comprises a first lower branch of said to and fro extending branches of said loop 12′ which is fixed to said holding bar 10′, and a second upper branch of said to and fro extending branches of said loop 12′ which is connected to the roll 9′ for winding and un-winding said splicing band 5′. Thus the first branch is arranged between said second branch and said working surface 3. Thus the second branches of said two loops 12, 12′ are arranged between said first branches of said two loops 12, 12′.

Subsequently, the second loop 12′ and first loop are arranged on top of said working surface 3, in particular on top of a butt line 1 on said working surface 3, wherein the to and fro extending branches of the first and second loop are arranged on top of each other and the first loop 12 is arranged on the second loop 12′ on said working surface 3, as shown in FIG. 5. The reversing loop part of the first loop 12 and second loop 12′ are retained at the side of the working surface 3 facing away from the holding frame 11 by means of a retainer 13, and the guide rolls 8, 8′ disengage the first loop 12 and the second loop 12′ respectively, and the transfer arm 7 moves out of the way.

Now the leading end and/or trailing end of the one or more strip-shaped members 2 are arranged at or near the butt line on top of the two loops of the splicing band. The splice band has a width which is sufficient to arrange both the leading end and trailing end of the strip-shaped member(s) on top of said splice band, thus the leading end and trailing end of the strip-shaped member(s) do not lie directly on the working surface 3. This leading end and trailing end of the strip-shaped member(s) are pushed against each other using a known stitching device to obtain a butt splice. The splicing of the strip-shaped member(s) 2 thus is performed on top of said two loops 12, 12′ of splicing band, on top of said working surface 3.

After the strip-shaped member(s) have been stitched, the retainer 13 is removed and the splicing bands are pulled in a pulling direction p, indicated by the arrows in FIG. 6, substantially parallel to the working surface 3 from underneath the butt spliced leading and trailing end of the strip-shaped member(s). The separator strips 5, 5′ are wound back on said rolls 9, 9′, and the transfer arm 8 and the guide rolls 8, 8′ can move back to the holding frame 11, to start the process all over again when required.

According to the invention, said separator strip 5 comprises a first release surface at a side which faces away from said working surface 3 and toward the strip-shaped member(s) 2. Although the strip-shaped member(s) may stick to some extend to the separator strip 5, in particular after the splicing of the strip-shaped member(s) 2 has been performed on top of said separator strip 5, the first release surface facilitates the removal of the separator strip or splicing bands from underneath the butt spliced strip-shaped member(s). In particular retracting said loop 12 by pulling the second lower branch of the loop 12, the first upper branch of the loop 12 is gradually peeled off from the underside of the strip-shaped member(s). The peeling off in particular takes place at the reversing loop part of the loop 12 which gradually moves along the underside of the strip-shaped member(s) when the loop 12 is retracted.

When the working surface 3 is of a nature that the separator strip 5 does not adhere onto or can slide over the working surface 3, the apparatus and the method of the invention only needs the first separator strip 5. However, when the working surface 3 is of a nature that the separator strip 5 may stick to some extend to the working surface, the use of a second separator strip 5′ is preferred. The use of two loops of separator strips 12, 12′ is in particularly advantageous for arranging and butt splicing second strip-shaped member(s) 2′ on top of previously arranged first strip-shaped member(s) 2 as schematically shown in FIG. 7. For example when arranging a body ply (second strip-shaped member) on top of a pre-assembly (first strip-shaped member) for manufacturing a tire component. Since both the body ply and the pre-assembly have a surface comprising uncured rubber, they usually strongly adhere to each other when the body ply is place on the pre-assembly.

Accordingly, said first separator strip 5 comprises a first release surface at a side which faces away from said working surface 3 and toward the second strip-shaped member(s) 2′ and said second separator strip 5′ comprises a second release surface at a side which faces toward said working surface 3 and toward the first strip-shaped member(s) 2. Although the first and second strip-shaped member(s) 2, 2′ may stick to some extend to the first and second separator strips 5, 5′, in particular after the splicing of the second strip-shaped member(s) 2′ has been performed on top of said separator strips 5, 5′ and said first strip-shaped member(s) 2, the first and second release surfaces facilitates the removal of the separator strips or splicing bands from in-between the first and second strip-shaped member(s). As described above, by retracting said first loop 12 by pulling the second lower branch of the first loop 12, the first upper branch of the second loop 12 is gradually peeled off from the underside of the second strip-shaped member(s) 2′. In addition, by retracting said second loop 12′ by pulling the second upper branch of the second loop 12′, the first lower branch of the second loop 12′ is gradually peeled off from the upper side of the first strip-shaped member(s) 2. The peeling off in particular takes place at the reversing loop part of the first and second loop 12, 12′ which gradually move along the under side of the second strip-shaped member(s) 2′ and along the upper side of the first strip-shaped member(s) 2, when the loops 12, 12′ are retracted. Preferably the second lower branch of the first loop 12 and the second upper branch of the second loop 12′ are pulled in at the same time and substantially at the same rate.

A second exemplary embodiment is schematically shown in FIGS. 8 to 11. Again, the working surface 3 can be a surface of a support device, for example a table top, a conveyor or a building drum, and in the context of this application can be a surface of a previously arranged strip-shaped member on said support device. Adjacent to a working surface 3 a separator strip system 11′ is arranged. Again, the separator strip system 11′ comprises two rolls 9, 9′ of separator strips 5, 5′, which are of a flexible material. The separator strips 5, 5′ are wound on said rolls 9, 9′. The ends of the separator strips 5, 5′ are fixed to the holding frame 11 via holding bars 10, 10′, which are arranged at a distance to each other.

In this second embodiment the separator strip system 11′ also comprises two extra redirecting rolls 18, 18′ which are arranged between the holding bars 10, 10′ such that the separator strips 5, 5′ are arranged between these redirecting rolls 18, 18′ and are redirected towards the holding bars 10, 10′. Thus the separator strips 5, 5′ are redirected from a substantially horizontal trajectory from the two rolls 9, 9′ to the redirecting rolls 18, 18′, to a substantially vertical trajectory form the redirecting rolls 18, 18′ to the holding bars 10, 10′.

Again, a transfer device 6 is arranged adjacent and over the working surface 3. The transfer device 6 comprises a transfer arm 7 which is movable from one side of the working surface 3 as shown in FIG. 1 to the other side of the working surface 3 as shown in FIG. 4. The transfer arm 7 is provided with two guide rolls 8, 8′. However the guide rolls 8, 8′ of this second embodiment are in a fixed position on the transfer arm. Preferably the two rolls 8, 8′ are freely rotatable arranged on the transfer arm 7.

The distance between the two rolls 8, 8′ is large enough so that these two rolls 8, 8′ can be moved past the redirecting rolls 18, 18′ and said redirecting rolls 18, 18′ can move in between said rolls 8, 8′. However the distance between the two rolls 8, 8′ is small enough so that these two rolls 8, 8′ pass between the holding bar 10, 10′.

As shown in FIG. 8, the transfer arm 7 is arranged between the holding bars 10, 10′ and the rolls 9, 9′ with the separator strips 5, 5′ thereon. When moving the two rolls 8, 8′ each between a corresponding set of a redirecting roll 18, 18′ and a holding bar 10, 10′, the two guide rolls 8, 8′ each pick up a separator strip 5, 5′ as shown in FIG. 9. As shown in FIG. 10, the transfer arm 7 is moved over the working surface 3 to the side facing away from the holding frame 11 and the separator strips are pulled over the working surface 3. Thus the transfer device 6 is arranged to arrange a first loop 12 and a second loop 12′ of said splice band 5, 5′ over said working surface 3, as shown in FIG. 10.

Again, the first separator strip 5 comprises a first upper branch of said to and fro extending branches of said loop 12 which is fixed to said holding bar 10, and a second lower branch of said to and fro extending branches of said loop 12′ which is connected to the roll 9 for winding and un-winding said splicing band 5. Thus the second branch is arranged between said first branch and said working surface 3. The second separator strip 5′ comprises a first lower branch of said to and fro extending branches of said loop 12′ which is fixed to said holding bar 10′, and a second upper branch of said to and fro extending branches of said loop 12′ which is connected to the roll 9′ for winding and un-winding said splicing band 5′. Thus the first branch is arranged between said second branch and said working surface 3. Thus the second branches of said two loops 12, 12′ are arranged between said first branches of said two loops 12, 12′.

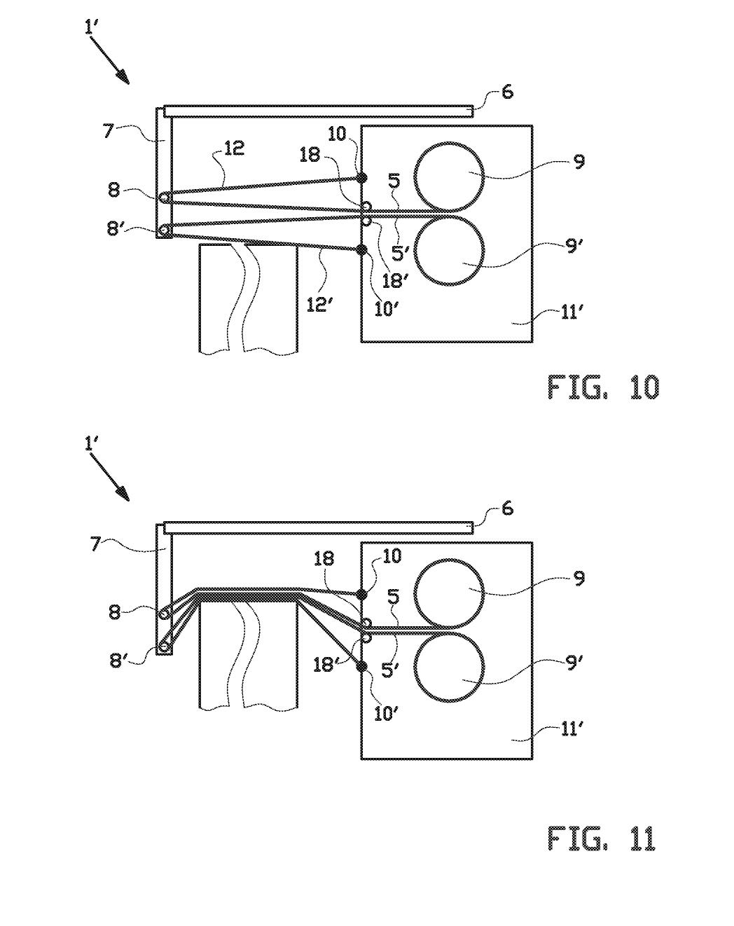

Subsequently, the second loop 12′ and first loop 12 are arranged on top of said working surface 3, in particular on top of a butt line 1 on said working surface 3, wherein the to and fro extending branches of the first and second loop are arranged on top of each other and the first loop 12 is arranged on the second loop 12′ on said working surface 3, as shown in FIG. 11. The rest of the device and method is exactly equal as in the first example with reference to FIGS. 5, 6 and 7. Please note that in this second example the guide rolls 8, 8′ are at a fixed position on the transfer arm 7, which allows the use of a transfer arm 7 which is much simpler engineered and easier to manufacture.

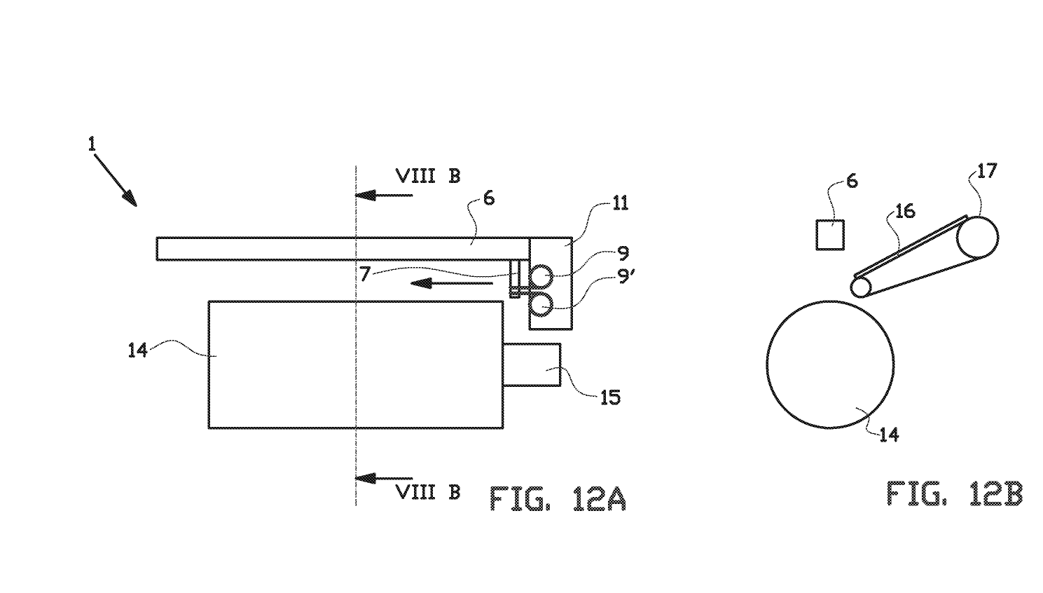

A third exemplary embodiment is schematically shown in FIGS. 12A to 18B. Again, adjacent to a working surface, a separator strip system is arranged. The working surface in this example is the circumferential surface of a building drum 14 which is rotatable around a drum shaft 15. The separator strip system is essentially the same as in the previous example and comprises a holding frame 11 with two rolls 9, 9′ of separator strips, also denoted as “splice band”. Again the splice bands are of a flexible material and are wound on said rolls 9, 9′. The ends of the separator strips fixed to the holding frame 11 via holding bars, not shown in detail, which are arranged at a distance to each other as shown in the FIGS. 1-7 and 8-11 of the previous examples.

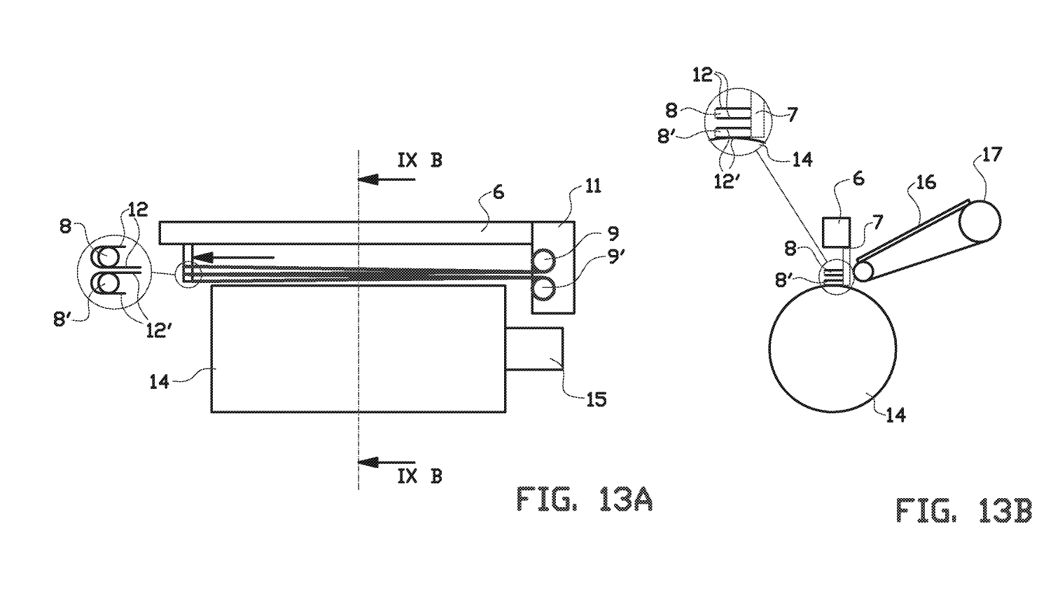

A transfer device 6 is arranged adjacent and over the working surface of the building drum 14. The transfer device 6 comprises a transfer arm 7 which movable from one side of the building drum 14 as shown in FIG. 12A to the other side of the building drum 14 as shown in FIG. 13A. Again, the transfer arm 7 is provided with two guide rolls 8, 8′ as shown in the details of FIGS. 13A and 13B. Preferably the two rolls 8, 8′ are freely rotatable arranged on the transfer arm 7 and are movable along the transfer arm 7 as in the first example, or are at a fixed position on the transfer arm 7 as in the second example.

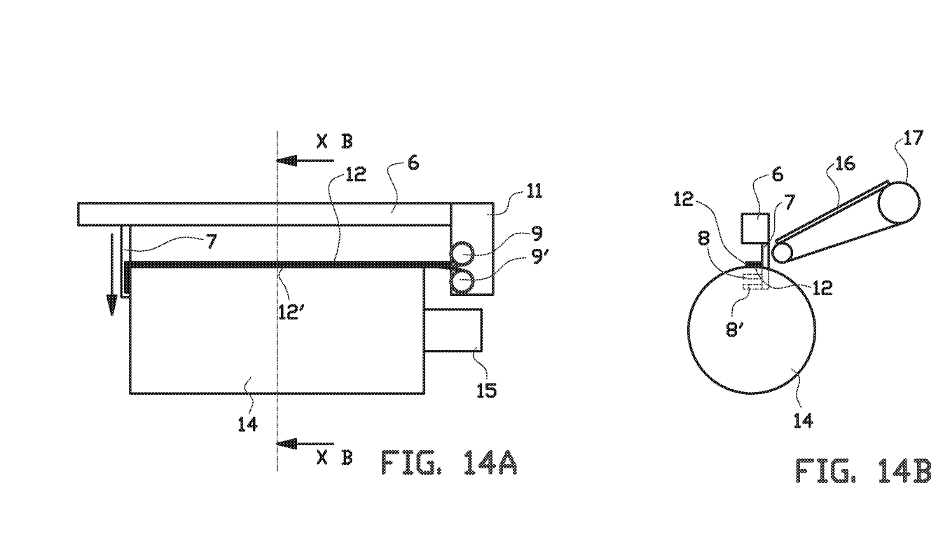

In the example, the two guide rolls 8, 8′ each pick up a separator strip as shown in FIG. 12A and the transfer arm 7 is moved over the working surface to the side of the building drum 14 facing away from the holding frame 11 and the separator strips are pulled over the working surface. Thus a first loop 12 and a second loop 12 of said splice band is arranged over said working surface of the building drum 14, as shown in FIG. 13A. Subsequently, the second loop 12′ and first loop 12 are arranged on top of said working surface of the building drum 14, in particular on top of a butt line which extends substantially parallel to a centre line of the building drum 14, as shown in FIGS. 14A and 14B. Since the separator strips are made from a flexible material, for example comprising a strip of flexible foil material, the separator strips will follow the contour of the building drum 14 when arranged thereon. Thus the separator strips comprise a curved surface having substantially the same radius of curvature as the circumferential surface of the building drum 14, or having substantially the same radius of curvature as the circumferential surface of another strip-shaped member 16 arranged around said building drum 14.

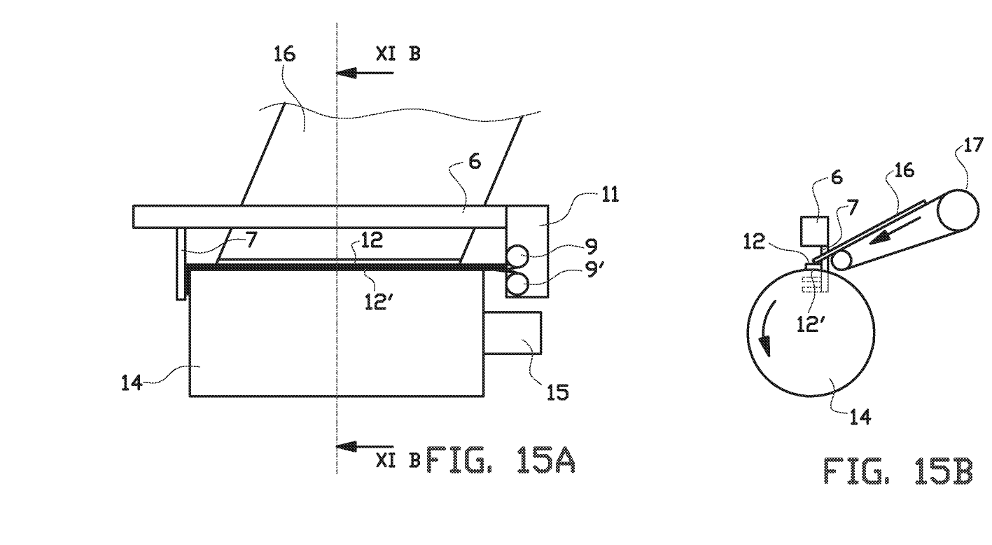

An arranging device, such as a conveyor 17, is provided for arranging the leading end of a strip-shaped member 16 at or near the butt line on top of the loops 12, 12′ of separator strip, as shown schematically in FIGS. 15A and 15B. Subsequently, the drum 14 is rotated around its drum shaft 15 and the strip-shaped member 16 is substantially synchronously moved from the conveyor 17 onto the drum in order to wrap the strip-shaped member 16 around the building drum 14. During this rotation of the building drum 14, the loops 12, 12′ of separator strip, which are arranged at the outside surface of the building drum 14 rotate together with the building drum 14. In the embodiment shown in FIGS. 15A and 15B, the holding frame 11 and the transfer device 6 synchronously rotate with the building drum 14.

Alternatively, when using a retainer 13 as shown in FIG. 5, the holding frame 11 and the retainer 13 synchronously rotate with the building drum. The transfer device 6 can then be arranged at a substantially fixed position with respect to the building drum 14, for example above the building drum 14.

The synchronously rotation can, for example, be established by connecting the frame 11 and the transfer device 6 or the retainer 13, to the building drum 14.

The length of the strip-shaped member 16 is set in order to establish that the trailing end of this strip-shaped member 16 is arranged near the leading end of the strip-shaped member 16 on the loops 12, 12′ of separator strip.

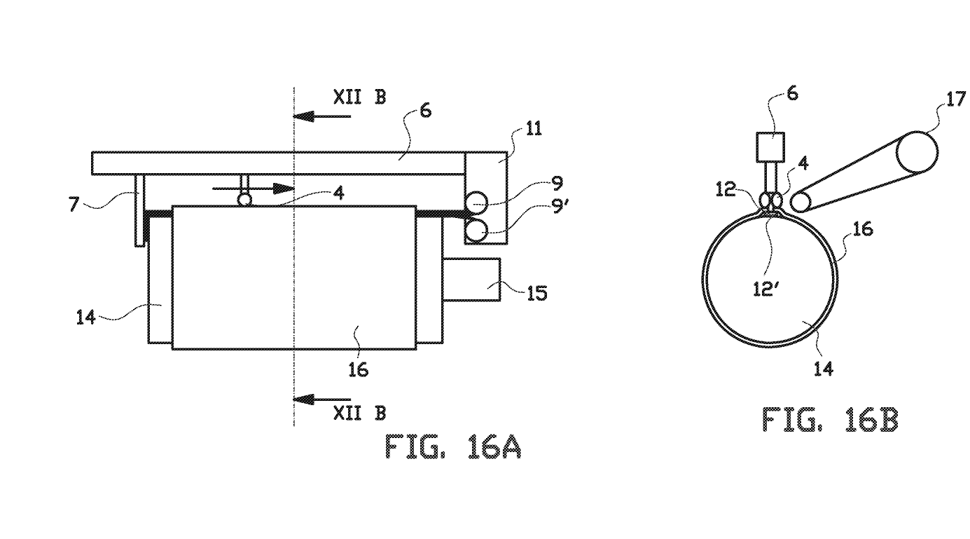

Subsequently the leading end and trailing end of this one strip-shaped member 16 are pushed against each other using a known stitching device 4 to obtain a butt splice. The splicing of the strip-shaped member 16 thus is performed on top of said two loops 12, 12′ of splicing band, on said building drum 14, as shown in FIGS. 16A and 16B. In this example the stitching device 4 is part of the transfer device 6 and moves along substantially the same path as the transfer arm 7.

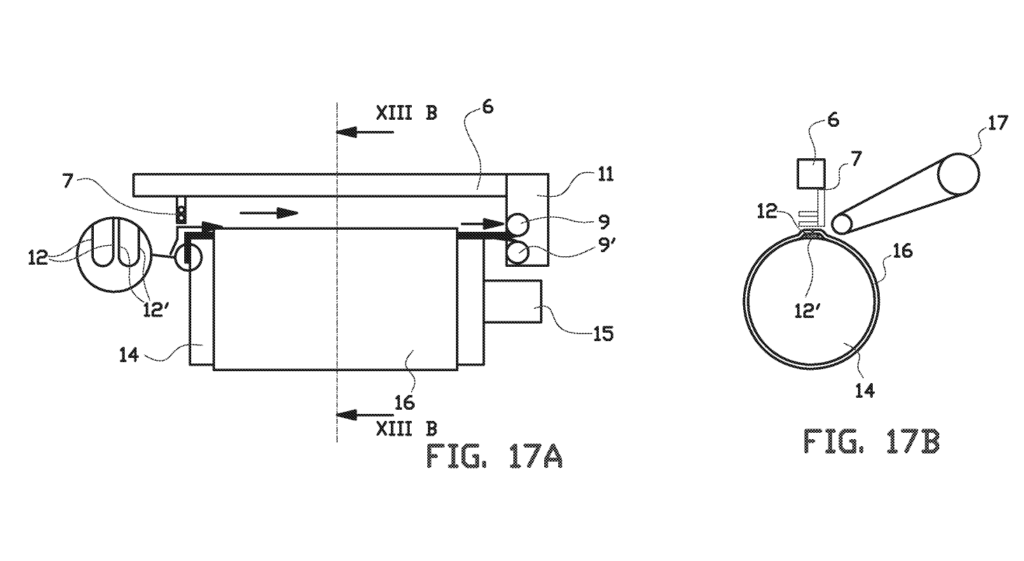

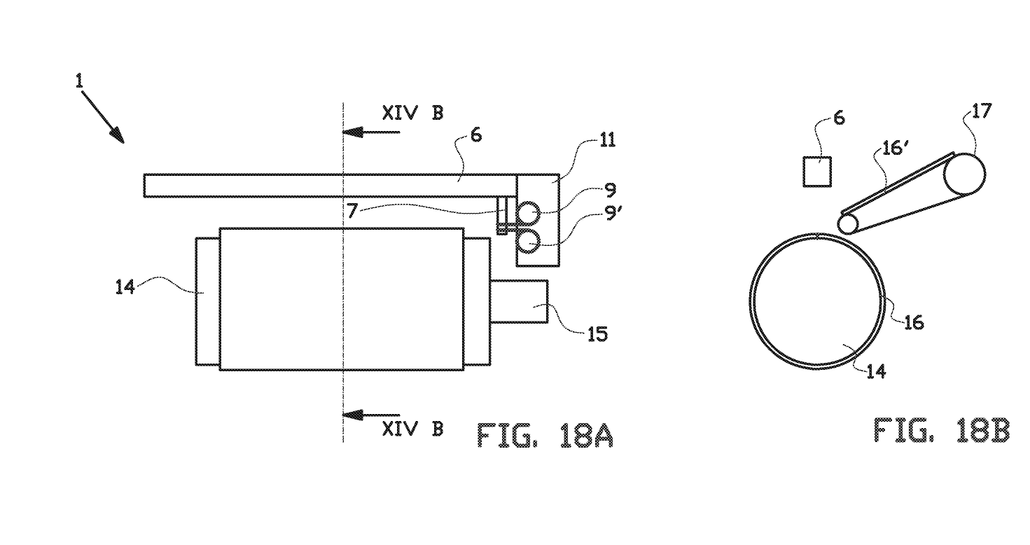

After the strip-shaped member 16 has been stitched, the guide rolls 8, 8′ disengage the first loop 12 and the second loop 12′ respectively, and the transfer arm 7 moves out of the way as shown in FIG. 17A. Subsequently, the splicing bands are pulled in a pulling direction p substantially parallel to the working surface from underneath the butt spliced leading and trailing end of the strip-shaped member 16. The separator strips are wound back on said rolls 9, 9′, and the transfer arm 7 and the guide rolls 8, 8′ can move back to the holding frame 11, to start the process all over again when required, as shown in FIGS. 18A and 18B, for example for arranging a second strip-shaped member 16′ on top of the previously arranged strip-shaped member 16, using the same method steps as described above.

Both the first and second example described above use flexible, preferably foil-shaped, separator strips which are arranged in a loop and placed on the working surface. Because of the loop-shape of the separator strips, the separator strips are peeled off from the under side of the strip-shaped member 2, 2′, 16, and/or from the upper side of the working surface 3. Due to this peeling action the strip-shaped member(s) are substantially not subjected to sideward forces, in particular no longitudinal forces with respect to a length direction of the strip-shaped member 2, 2′, 16, when the separator strips are removed.

It is to be understood that the above description is included to illustrate the operation of the preferred embodiments and is not meant to limit the scope of the invention. From the above discussion, many variations will be apparent to one skilled in the art that would yet be encompassed by the spirit and scope of the present invention.

In summary, the present invention relates to an apparatus and method for joining a leading and a trailing end of one or more strip-shaped members, said apparatus comprises:

a working surface comprising a butt line,

an arranging device for arranging the leading and trailing end of the member(s) at the butt line,

a stitching device for pushing the leading and trailing ends against each other to obtain a butt splice,

a transfer device for moving a separator strip onto and away from said working surface, wherein said separator strip is a flat strip comprising a splice band of a flexible material and a first release surface at a side which faces away from said working surface, and wherein said apparatus is arranged for pulling said separator strip from underneath the butt spliced strip-shaped member(s).

1-29. (canceled)

30. Apparatus for arranging a leading and a trailing end of one or more strip-shaped members on a surface at or near a butt line, wherein the apparatus comprises:
a working surface comprising the butt line,
an arranging device for arranging the leading and/or the trailing end of one or more strip-shaped members at or near the butt line on the working surface,
a stitching device which is movable along the butt line, wherein said stitching device comprises a stitching member for pushing the leading and trailing ends against each other to obtain a butt splice,
a separator strip which is movable onto said working surface and away from said working surface, wherein said separator strip has a width, when arranged on said working surface, to cover said butt line and an area of said working surface on both sides adjacent to said butt line,
a transfer device for moving said separator strip onto said working surface and away from said working surface, characterized in that
said separator strip is a flat strip comprising a splice band of a flexible material and a first release surface at a side which faces away from said working surface, and
wherein said apparatus is arranged for pulling said separator strip in a pulling direction parallel to the working surface from underneath the butt spliced leading and trailing end of the one or more strip-shaped members.

31. Apparatus according to claim 30, wherein said transfer device is arranged to place said splice band on said working surface and to retain said splice band along said butt line at opposite sides of said working surface.

32. Apparatus according to claim 31, wherein said transfer device is arranged to place a loop of said splice band on said working surface, and to retain to and fro extending branches of said loop on a first side of the working surface and to retain a reversing loop part on a second side of the working surface, wherein said first and second side are arranged along said butt line at opposite sides of said working surface.

33. Apparatus according to claim 32, wherein said transfer device is arranged to place said to and fro extending branches on top of each other on said working surface.

34. Apparatus according to claim 31, wherein a first branch of said to and fro extending branches of said loop is fixed to said transfer device, and wherein a second branch of said to and fro extending branches of said loop is connected to a roll for winding and un-winding said splicing band.

35. Apparatus according to claim 34, wherein the second branch is arranged between said first branch and said working surface.

36. Apparatus according to claim 30, wherein said transfer device is arranged to place two loops of said splicing band on said working surface and to retain to and fro extending branches of each of said two loops on a first side of the working surface and to retain a reversing loop part of each of said two loops on a second side of the working surface, wherein said first and second side are arranged along said butt line at opposite sides of said working surface.

37. Apparatus according to claim 36, wherein said transfer device is arranged to place said to and fro extending branches of said two loops on top of each other on said working surface.

38. Apparatus according to claim 36, wherein for each one of said two loops a first branch of said to and fro extending branches is fixed to said transfer device, and wherein a second branch of said to and fro extending branches is connected to a roll for winding and un-winding said splicing band.

39. Apparatus according to claim 38, wherein the second branches of said two loops are arranged between said first branches of said two loops.

40. Apparatus according to claim 30, wherein the splice band is made from a non-stick material or a material which does not stick to uncured rubber.

41. Apparatus according to claim 30, wherein the separator strip comprises a second release surface at a side which faces towards said working surface in order to prevent the separator strip to adhere to said working surface.

42. Apparatus according to claim 30, wherein said pulling direction is parallel to the butt line.

43. Apparatus according to claim 30, wherein said apparatus comprises a drum having a circumferential surface, and wherein said working surface comprises said circumferential surface of said drum or comprises a circumferential surface of another strip-shaped member arranged around said drum.

44. Apparatus according to claim 43, wherein said drum is rotatable around a center line thereof and wherein said separator strip and/or said transfer device arranged to rotate together with said drum.

45. Apparatus according to claim 44, wherein said separator strip and/or said transfer device is arranged to provide a rotation fixed coupling with said drum.

46. Method for arranging a leading and a trailing end of one or more strip-shaped members on a surface at or near a butt line, wherein the method comprises the steps of:
providing a working surface comprising the butt line,
arranging a separator strip onto said working surface, wherein said separator strip is a flat strip comprising a splice band of a flexible material and a first release surface at a side which faces away from said working surface, and wherein said separator strip is arranged to cover said butt line and an area of said working surface on both sides adjacent to said butt line,
arranging the leading and the trailing end of one or more strip-shaped members at or near the butt line on the separator strip on said working surface,
pushing the leading and trailing ends against each other to obtain a butt splice, and
pulling said separator strip in a pulling direction parallel to the working surface from underneath the butt spliced leading and trailing end of the one or more strip-shaped members.

47. Method according to claim 46, wherein the splice band is placed on said working surface and retained along said butt line at opposite sides of said working surface.

48. Method according to claim 47, wherein a loop of said splice band is placed on said working surface, and wherein to and fro extending branches of said loop are retained on a first side of the working surface and a reversing loop part is retained on a second side of the working surface, wherein said first and second side are arranged along said butt line at opposite sides of said working surface.

49. Method according to claim 48, wherein said to and fro extending branches are placed on top of each other on said working surface.

50. Method according to claim 48, wherein a first branch of said to and fro extending branches of said loop is fixed to said transfer device, and wherein a second branch of said to and fro extending branches of said loop is connected to a roll, wherein the method comprises winding and un-winding said splicing band.

51. Method according to claim 50, wherein the second branch is arranged between said first branch and said working surface.

52. Method according to claim 46, wherein two loops of said splicing band are placed on said working surface, and wherein to and fro extending branches of each of said two loops are retained on a first side of the working surface and a reversing loop part of each of said two loops is retained on a second side of the working surface, wherein said first and second side are arranged along said butt line at opposite sides of said working surface.

53. Method according to claim 52, wherein said to and fro extending branches of said two loops are placed on top of each other on said working surface.

54. Method according to claim 52, wherein for each one of said two loops a first branch of said to and fro extending branches is fixed to said transfer device, and wherein a second branch of said to and fro extending branches is connected to a roll, wherein the method comprises winding and un-winding said splicing band.

55. Method according to claim 53, wherein the second branches of said two loops are arranged between said first branches of said two loops.

56. Method according to claim 46, wherein the splice band is made from a non-stick material or a material which does not stick to uncured rubber.

57. Method according to claim 46, wherein said separator strip comprises a second release surface at a side which faces towards said working surface.

58. Method according to claim 46, wherein said pulling direction is parallel to the butt line.
